(19) United States
(12) Patent Application Publication
(10) Pub. No.: US 2009/0248919 A1
(43) Pub. Date: Oct. 1, 2009

(54) METHOD FOR EXTERNAL FIFO ACCELERATION

(76) Inventors: Jerzy Szwagrzyk, Monument, CO (US); Garret Davey, Colorado Springs, CO (US); Jeffrey K. Whitt, Colorado Springs, CO (US)

Correspondence Address: COCHRAN FREUND & YOUNG LLC;LSI CORPORATION, 2026 CARIBOU DRIVE, SUITE 201, FORT COLLINS, CO, 80525, US

(21) Appl. No.: 12/054,988

(22) Filed: Mar. 25, 2008

(51) Int. Cl. G06F 3/00

(52) U.S. Cl. 710/52

(57) ABSTRACT

Disclosed is a pre-fetch system in which data blocks are transferred between a RAM 116 and an interface 106. Data can be read eight, four, or twice as fast using the pre-fetch technique. Data is stored in a pre-fetch buffer for immediate access and use.

### BACKGROUND OF THE INVENTION

In modern computer systems, input/output devices (I/O devices) are used to access data for read and write operations. First in/first out (FIFO) registers are typically used to buffer data and match data transfer rates between devices. FIFO registers can comprise hardware registers which produce data on the following clock pulse or can be implemented in RAM that can be programmed for the size of the data to be stored. Implementation of FIFO's in RAM has many other advantages as well as some disadvantages.

### SUMMARY OF THE INVENTION

An embodiment of the present invention may comprise A method of transferring data between an interface and a RAM comprising transferring the data in a plurality of data blocks from the interface device over an internal bus to the RAM, the internal bus having a predetermined bit width; storing the data in the RAM in a virtual FIFO memory; receiving a request for a predetermined data block of the plurality of data blocks from the computer bus; retrieving a set of data blocks of the plurality of data blocks, including the predetermined data block from the virtual FIFO memory over the internal bus, the set of data blocks having a combined bit width that substantially matches the predetermined bit width of the internal bus; storing the set of data blocks in a pre-fetch buffer for direct access by the interface; accessing the set of data in the pre-fetch buffer for use in the interface without delay associated with transfer of the data through the internal bus.

An embodiment of the present invention may further comprise A system for transferring data comprising an interface; a RAM; an internal bus connected to the interface and the RAM that transfers the data blocks from the interface to a virtual FIFO memory in the RAM and, in response to a request for a predetermined data block of the plurality of data blocks, pre-fetches a set of data blocks having a combined bit width that substantially matches a predetermined bit width of the internal bus; a pre-fetch buffer disposed in the interface that stores the data blocks for direct access by the interface without delay associated with transfer of the data blocks over the internal bus.

### BRIEF DESCRIPTION OF THE DRAWINGS

FIG. 1 is a schematic block diagram of a storage architecture used in accordance with the present invention.

FIG. 2 is an additional block diagram of the storage architecture illustrated in FIG. 1.

FIG. 3 is a schematic illustration of the manner in which data can be transferred over a bus.

FIG. 4 is a schematic illustration of another method of transferring data over a bus.

### DETAILED DESCRIPTION OF THE EMBODIMENTS

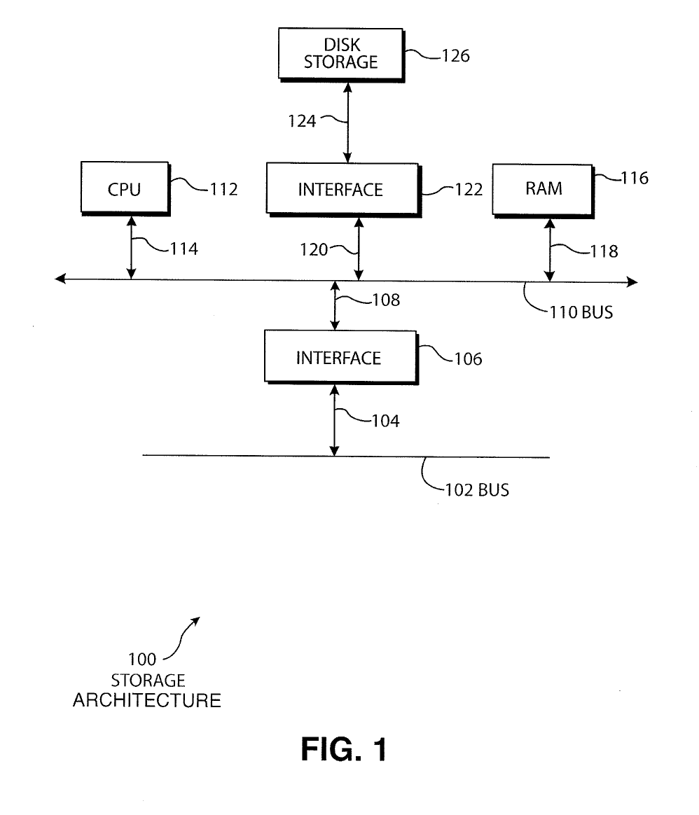

FIG. 1 is a schematic block of storage architecture 100 for an input/output device for accessing data from disk storage from a computer bus 102, such as a PCI Express bus. As shown in FIG. 1, the bus 102 may comprise a primary bus in a computer system. An interface 106 may be part of a chip that is connected via 104 to the bus 102. The interface 106 may provide, for example, an interface for retrieving and storing data to and from disk storage 126 via connector 124. Interface 106 is connected to an internal bus 110, such as a Power PC 128-bit wide local bus via 108. Similarly, CPU 112 is connected via 114 to bus 110. RAM 116 is also connected to bus 110 via 118. An additional interface 122 is connected to RAM 120 which accesses the disk storage via 124.

In operation, the storage architecture 100 operates as follows. When data is to be written from the bus 102, data is transferred to interface 106 which interfaces the protocol of the PCI Express bus 102 to the protocol of the Power PC local bus 110. In addition, interface 106 provides data storage and access control. CPU 112 controls the transfer of data from the interface 106 to RAM 116 or data can be transferred under the control of interface 106 using bus mustering techniques.

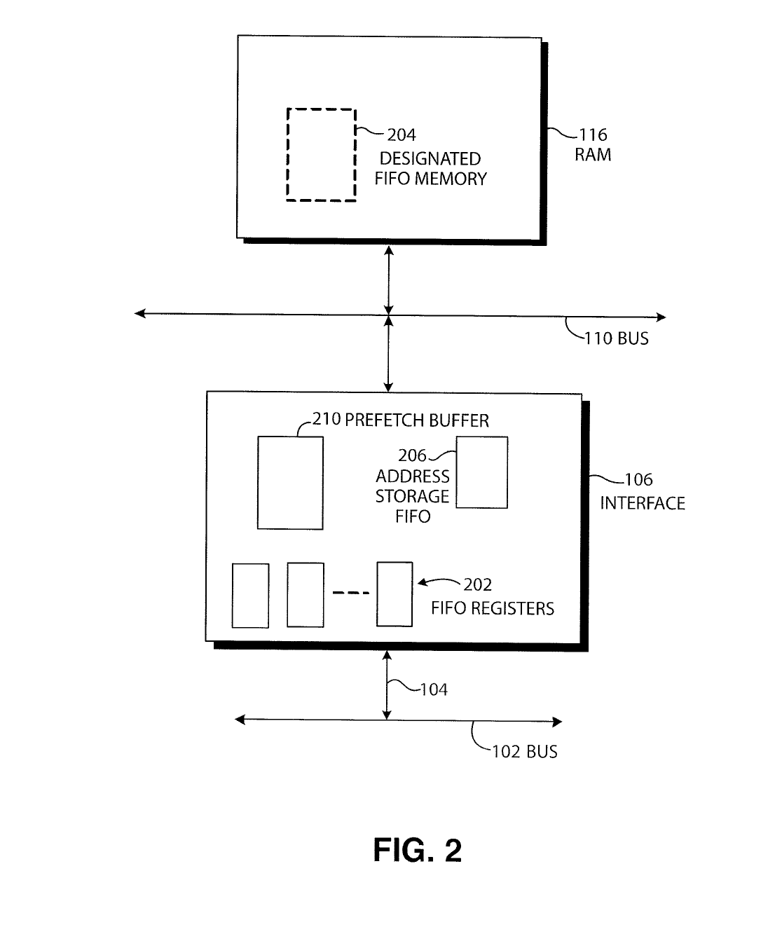

FIG. 2 is a more detailed diagram of the interface 106, bus 110 and RAM 116. As shown in FIG. 2, interface 106 is connected to the bus 102 via 104. Interface 106 may contain FIFO registers 202 that comprise hardware FIFO registers. FIFO registers 202 may be arranged to receive and transmit data via 104 to provide immediate buffering between the bus 102 and bus 110. When a large amount of data, however, must be stored, RAM 116 can be used to store this data since it would be cost prohibitive to provide sufficient storage on the interface device 106. Areas in the RAM 116 can be designated as FIFO memory for storage of internal operational data for interface 106. For example, FIFO 204 in RAM 116 can be designated by the interface 106 to store operational data in the same manner as a hardware FIFO. Operational data can then be stored in the designated FIFO memory 204 in RAM 116 prior to use by interface 106. Numerous FIFO memories can be designated in RAM 116 to store operational data. The main data may be stored in other parts of RAM 116. Transfer of data to and from FIFO 204 occurs over the internal 128-bit bus 110 between the interface 106 and RAM 116. The data blocks can be various sizes including 64 bits wide, 32 bits wide, 16 bits wide, or other sizes. These data blocks are transferred over the bus 110 in accordance with the protocol of the bus 110. The transfer of data over the internal bus 110 may require a number of clock pulses resulting in a significant delay. For example, storage and retrieval of data in a designated FIFO memory 204 in a RAM 116 can be delayed up to 30 clock pulses or more in some implementations, as a result of delays produced by internal bus 110. Hence, although the designated FIFO memory 204 has the advantage of being adjustable to the particular size necessary, the transfer of data between RAM 116 and interface 106 can be substantially delayed by the bus 110.

The bus 110, illustrated in FIG. 2, may be a 128-bit bus, as indicated above. A process of pre-fetching can be utilized to transfer data blocks over the bus 110. For example, if a 32-bit data block must be transferred from the designated FIFO memory 204 to the interface 106, four contiguous 32-bit FIFO data blocks will be transferred from the designated FIFO memory 204 through the bus 110 to the interface 106. The four blocks of 32-bit wide data are then stored in the pre-fetch buffer 210. Pre-fetch buffer 210 provides the four blocks of 32-bit wide data so that the four blocks of 32-bit wide data are readily accessible in the interface 106. Although there is a delay in obtaining the first 32-bit data block from RAM 116, which may be substantial, the remaining three data blocks, that are stored in pre-fetch buffer 210, can be accessed within one clock pulse. Hence, by pre-fetching the three additional data blocks, the system illustrated in FIG. 2 can operate up to four times faster than comparable systems that require the transfer of individual data blocks over bus 110 each time data is accessed. If 64-bit wide data blocks are utilized, the system illustrated in FIG. 2 will operate twice as fast as systems that do no pre-fetch data. If 16-bit wide data blocks are utilized, the system will operate up to eight times as fast as systems that do not pre-fetch data. In this manner, the full capacity of the 128-bit bus is utilized to pre-fetch data in an efficient manner and store pre-fetched data in a pre-fetch buffer 210 for immediate use. In addition, this greatly reduces the amount of storage that is required in the interface 106, while allowing quick access to such data by pre-fetching.

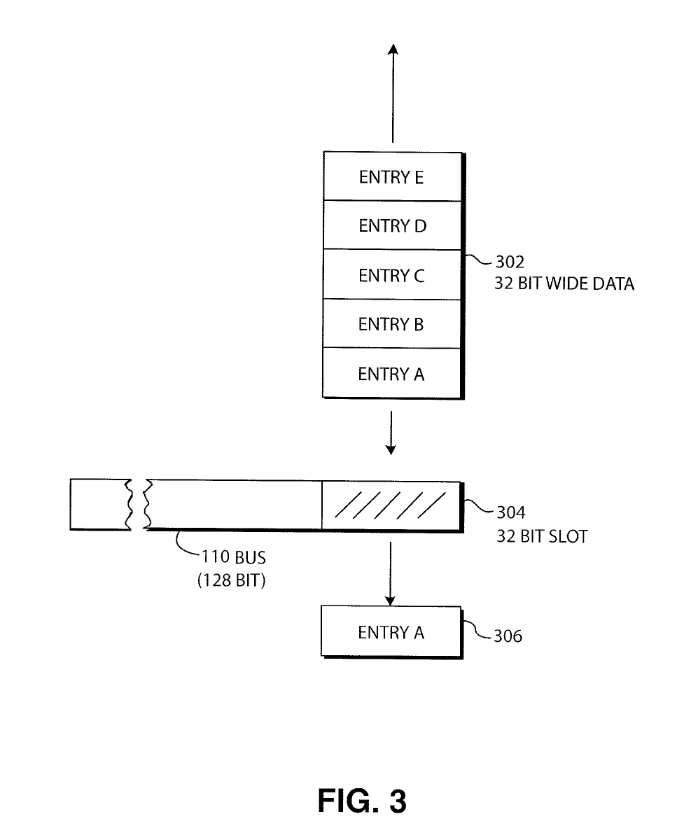

FIG. 3 is a schematic illustration of the manner in which data can be transferred over a bus. As shown in FIG. 3, a series of 32-bit wide data blocks 302 are individually transferred through a bus 110 to an output 306. As shown in FIG. 3, only a 32-bit slot 304 in the bus 110 is utilized to transfer data. The remaining 96 bits of the bus are not used in that type of transfer.

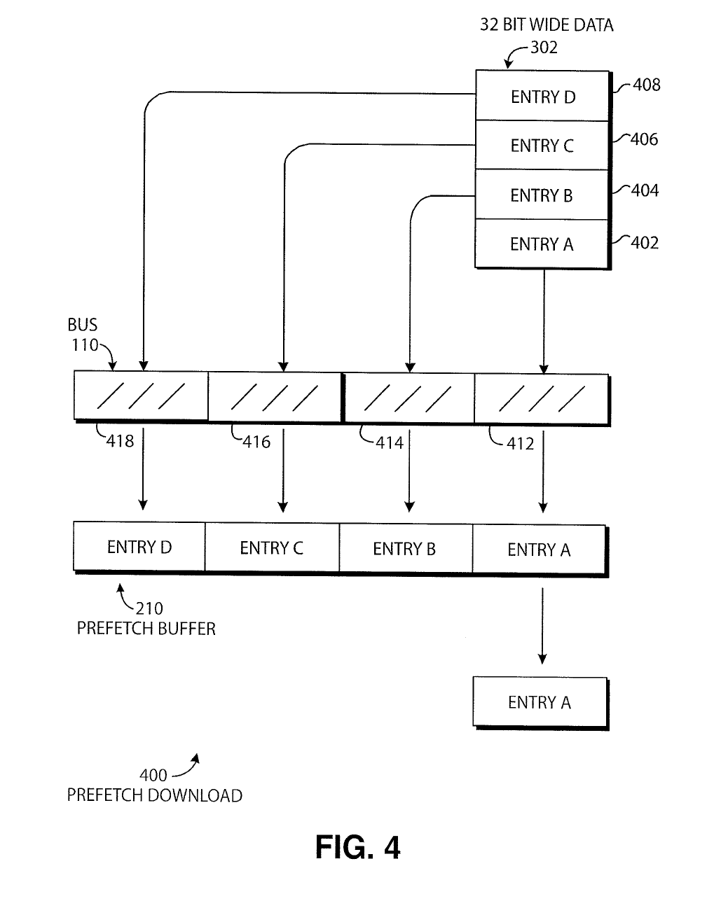

FIG. 4 is a schematic illustration of the manner in which the full 128 bits of the bus 110 can be utilized. FIG. 4 illustrates the pre-fetched download technique 400 that is utilized in accordance with the embodiment illustrated in FIG. 2. As shown in FIG. 4, data blocks 402, 404, 406, 408 are transferred to slots 412, 414, 416, 418 in bus 110. In other words, there is a parallel transfer of the 32-bit wide data blocks 402-408 stored in FIFO 302 to the bus 110. The bus 110 then transfers the data to the pre-fetch buffer 210 that is disposed in the interface 106. The pre-fetch buffer 210 stores the data so that it can be readily accessed and used by interface 106.

Hence, data is pre-fetched from RAM 116 and transferred to a pre-fetch buffer 210 for storage and immediate use in the interface 106. In this manner, transfer of 32-bit wide data blocks can occur up to four times faster than individual transfers of data, while 16-bit blocks can be transferred up to eight times as fast, and 64-bit blocks can be transferred twice as fast as individual transfers of data.

What is claimed is:

1. A method of transferring data between an interface and a RAM comprising:
transferring said data in a plurality of data blocks from said interface device over an internal bus to said RAM, said internal bus having a predetermined bit width;
storing said data in said RAM in a virtual FIFO memory;
receiving a request for a predetermined data block of said plurality of data blocks from said computer bus;
retrieving a set of data blocks of said plurality of data blocks, including said predetermined data block from said virtual FIFO memory over said internal bus, said set of data blocks having a combined bit width that substantially matches said predetermined bit width of said internal bus;
storing said set of data blocks in a pre-fetch buffer for direct access by said interface;
accessing said set of data in said pre-fetch buffer for use in said interface without delay associated with transfer of said data through said internal bus.

2. The method of claim 1 wherein said process of transferring said data comprises:
transferring said data in a plurality of data blocks in a plurality of data blocks that are 32 bits wide.

3. The method of claim 2 wherein said process of transferring said data comprises:
transferring said data from said interface device over an internal bus to a RAM, said internal bus having a predetermined bit width of 128 bits.

4. The process of claim 3 further comprising:
storing address information relating to addresses of said blocks in said interface device.

5. A system for transferring data comprising:
an interface;
a RAM;
an internal bus connected to said interface and said RAM that transfers said data blocks from said interface to a virtual FIFO memory in said RAM and, in response to a request for a predetermined data block of said plurality of data blocks, pre-fetches a set of data blocks having a combined bit width that substantially matches a predetermined bit width of said internal bus;
a pre-fetch buffer disposed in said interface that stores said data blocks for direct access by said interface without delay associated with transfer of said data blocks over said internal bus.

6. The device of claim 5 wherein said interface further comprises an address FIFO that stores addresses of said data blocks stored in said virtual FIFO.

7. The device of claim 6 wherein said predetermined bit width of said bus is 128 bits.
